(19) United States
(12) Patent Application Publication
(10) Pub. No.: US 2005/0061114 A1
(43) Pub. Date: Mar. 24, 2005

(54) Ratchet wrench

(76) Inventors: Wen-Hsiung Lin, Taiping City (TW); Kuan-Hung Liu, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/664,957

(22) Filed: Sep. 22, 2003

(51) Int. Cl. B25B 13/00

(52) U.S. Cl. 81/59.1

(57) ABSTRACT

A ratchet wrench includes a handle with an enlarged head formed on one end of the handle and a neck integrally formed between the handle and the enlarged head. A cavity is defined in and extends through the enlarged head. The cavity has an axis perpendicularly corresponding to that of the handle. A ratchet set is pivotally received in the cavity and has multiple rotors rotatably abutting an inner periphery of the cavity. An actuated stub centrally extends from the ratchet set for driving a workpiece. A channel is defined in the neck, thereby a thickness between the channel and the cavity is equal to the thickness between the inner periphery of the cavity and an outer periphery of the enlarged head to promote the effect of heat treatment in the inner periphery of the cavity.

### BACKGROUND OF THE INVENTION

1. Field of the Invention

The present invention relates to a ratchet wrench, and more particularly to a ratchet wrench includes a channel defined in a neck thereof for promoting an effect of the heat treatment.

2. Description of Related Art

With reference to FIG. 6, a conventional ratchet wrench comprises a handle (6), an enlarged head (61) form on one end of the handle (6). A hole (62) is defined in the enlarged head (61) and has a teethed inner periphery. A drive device (7) in received in the hole (62). The drive device (7) has a pawl (71) engaged to the teethed inner periphery of the hole (62) such that the ratchet wrench is capable of driving a workpiece. The operate direction is changed when adjusting the position of the pawl (71).

However, the pawl (71) is engaged to the teethed inner periphery of the hole (62) such that the height of ratchet is limited and the conventional ratchet wrench cannot be used in a high torsion work.

For overcoming the above problem, another ratchet wrench is marketed, as shown in FIG. 7. The second conventional ratchet wrench includes a handle (8) having an enlarged head (81) integrally formed on one end of the handle (8). A first cavity (82) is defined in the enlarged head (81) and a driving device (9) is mounted in the cavity (82). The drive device has a ratchet pivotally mounted in the first cavity (82). A second cavity (84) is defined in the enlarged head (81) and laterally communicates with first cavity (82). Two pawls (83) is movably mounted in the second cavity (84) and selective engaged to the ratchet (91) for changing the operate direction of the second conventional ratchet wrench.

The second conventional ratchet wrench can provide a great torsion during working. However, the second ratchet wrench needs to define a second cavity (84) for receiving the two pawls (83) such that the manufacturing processes is complicated and takes a high price.

The present invention has arisen to mitigate and/or obviate the disadvantages of the two conventional ratchet wrenches.

### SUMMARY OF THE INVENTION

The main objective of the present invention is to provide an improved ratchet wrench that has a good effect of heat treatment.

To achieve the objective, the ratchet wrench in accordance with the present invention comprises a handle with an enlarged head formed on one end of the handle and a neck integrally formed between the handle and the enlarged head. A cavity is defined in and extends through the enlarged head. The cavity has an axis perpendicularly corresponding to that of the handle. A ratchet set is pivotally received in the cavity and has multiple rotors rotatably abutting an inner periphery of the cavity. An actuated stub centrally extends from the ratchet set for driving a workpiece. A channel is defined in the neck, thereby a thickness between the channel and the cavity is equal to the thickness between the inner periphery of the cavity and an outer periphery of the enlarged head to promote the effect of heat treatment in the inner periphery of the cavity.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a ratchet wrench in accordance with the present invention;

FIG. 2 is an exploded perspective view of the ratchet wrench in FIG. 1;

FIG. 3 is a top plan view of the enlarged head of the handle of the ratchet wrench for showing a ratchet set received in a cavity in the enlarged head FIG. 4 is a top plan view of the enlarged head of the handle;

FIG. 5 is a second embodiment of the enlarged head of the present invention;

FIG. 6 is a top plan view of an enlarged head of a first conventional ratchet wrench in accordance with the prior art; and

FIG. 7 is a top plan view of an enlarged head of a second conventional ratchet wrench in accordance with the prior art.

### DETAILED DESCRIPTION OF THE INVENTION

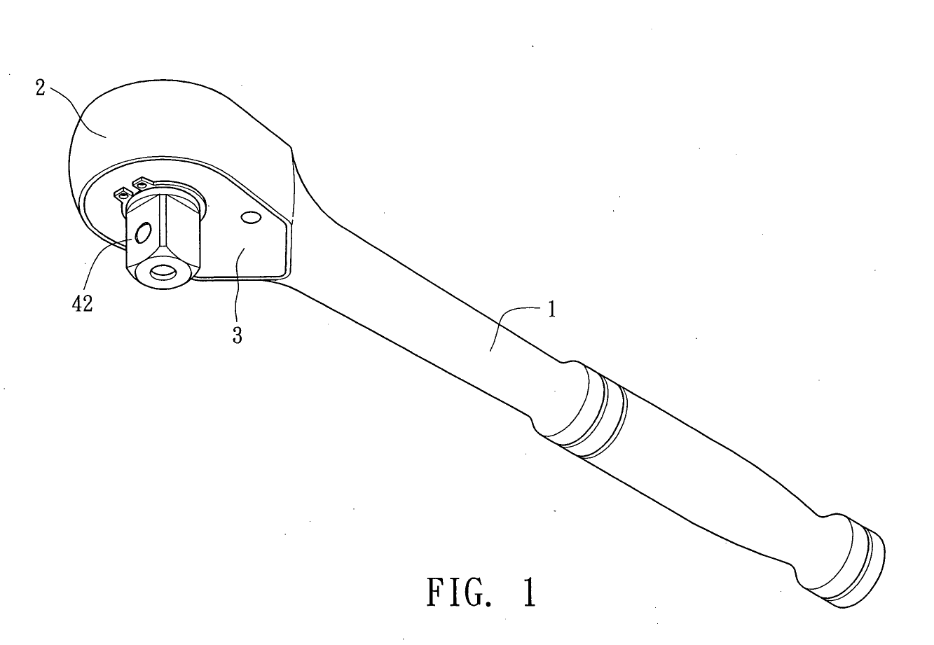

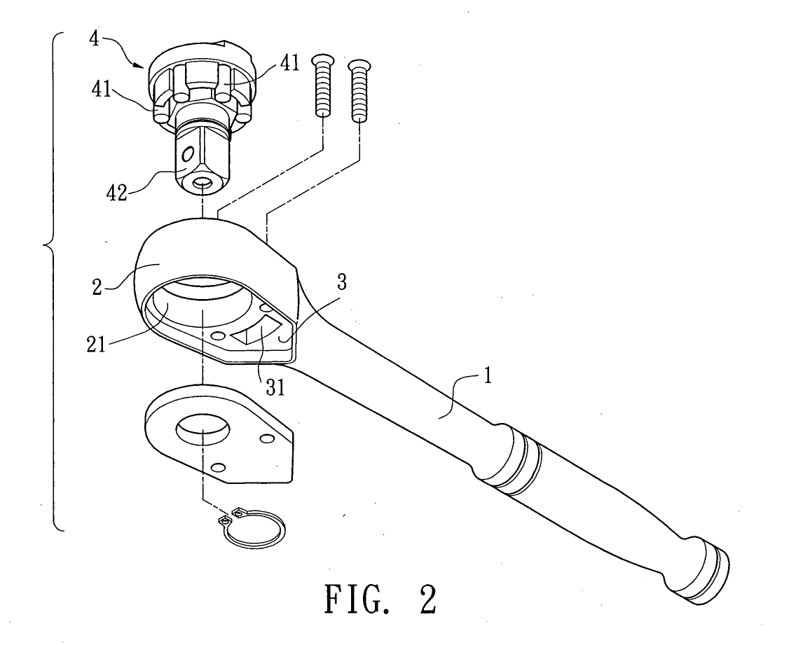

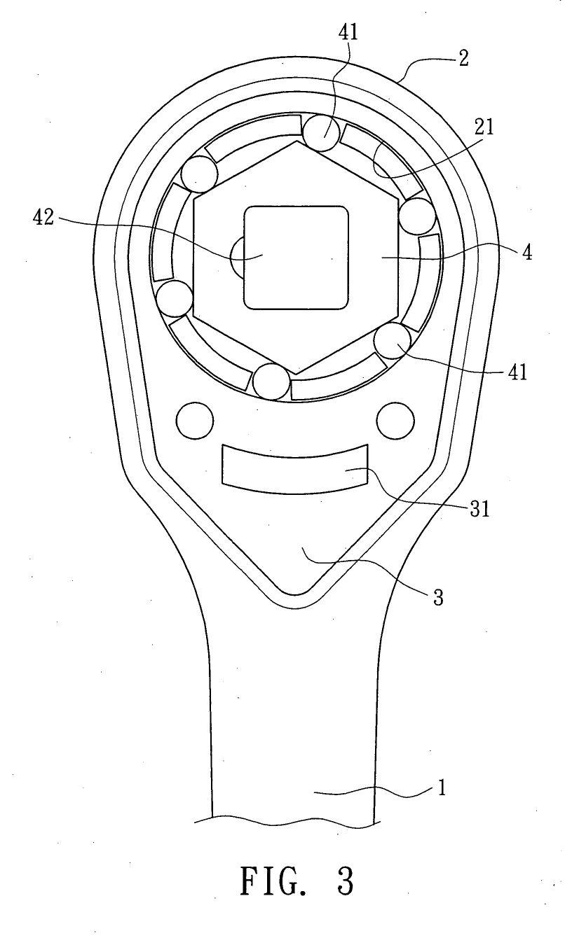

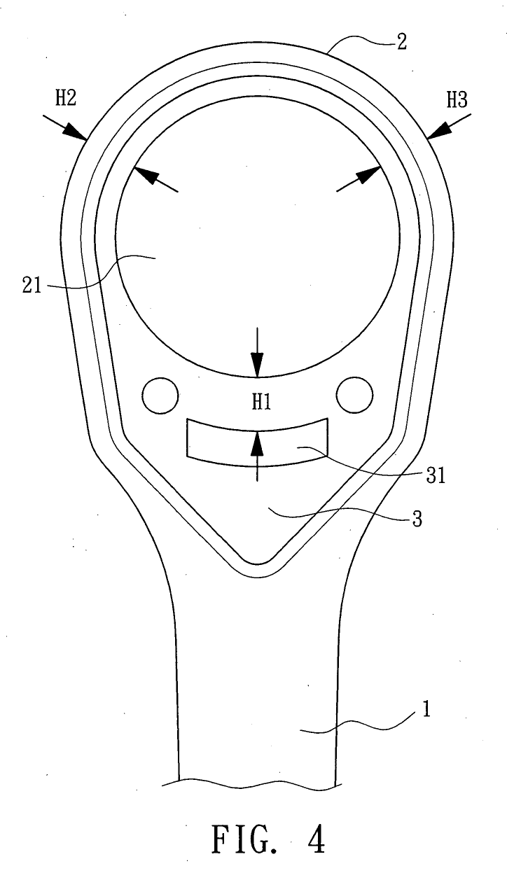

Referring to the drawings and initially to FIGS. 1-4, a ratchet wrench in accordance with the present invention comprises a handle (1) with an enlarged head (2) formed on one end of the handle (1) and a neck (3) is integrally formed between the handle (1) and the enlarged head (2). A cavity (21) is defined in and extends through the enlarged head (2). The cavity (21) has an axis perpendicularly corresponding to that of the handle (1). A ratchet set (4) is pivotally received in the cavity (21) and has multiple rotors (41) rotatably abutting an inner periphery of the cavity (21). An actuated stub (42) centrally extends from the ratchet set (4) for driving a workpiece.

A channel (31) is defined in the neck (3). In the preferred embodiment of the present invention, the channel (31) is arc and has a curvature corresponding to that of the cavity (21). Consequently, a thickness (H1) between the channel (31) and the cavity (21) is equal to the thickness (H2, H3) between the inner periphery of the cavity (21) and an outer periphery of the enlarged head (2). Consequently, the hardness is equally distributed to the inner periphery of the cavity (21) for elongating the using life of the ratchet wrench.

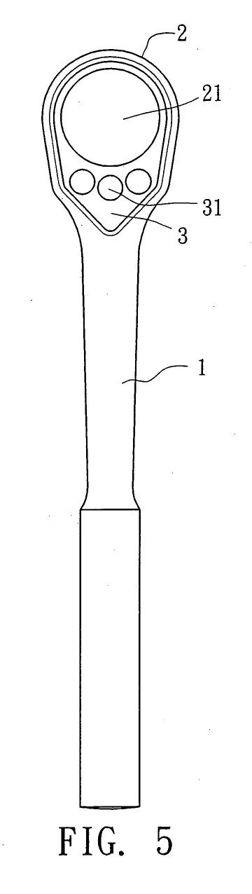

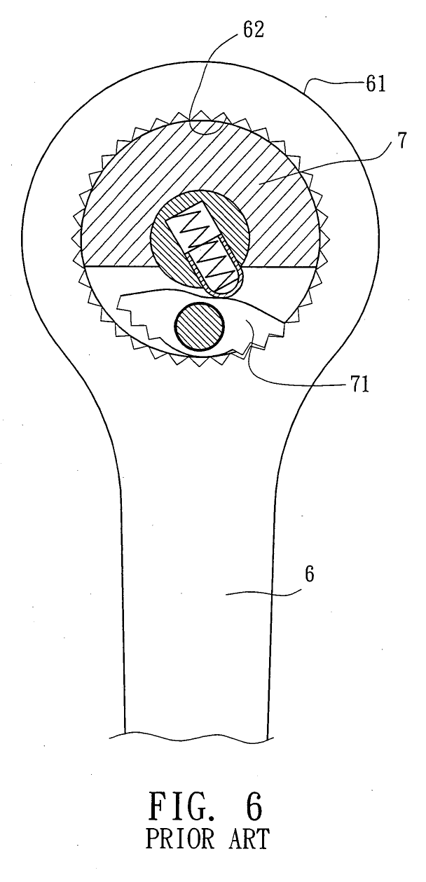

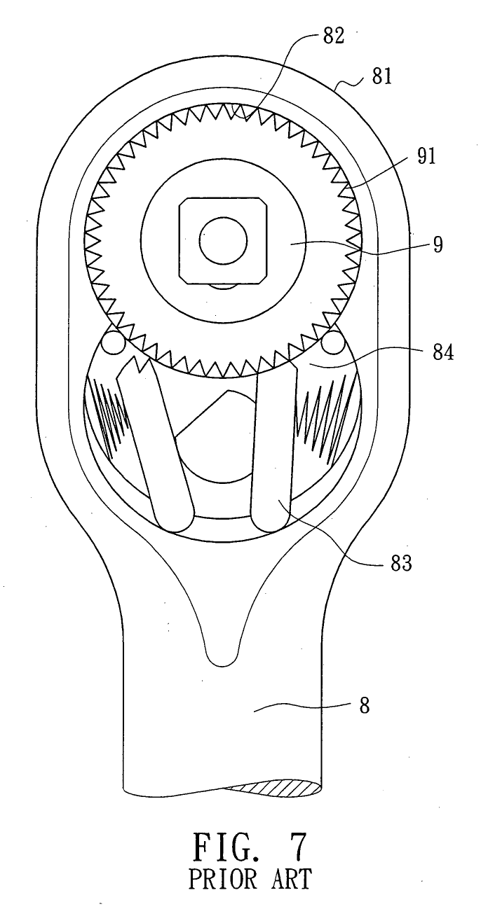

In the preferred embodiment as shown in FIGS. 1-4, the channel (31) is provided to a great size of the ratchet wrench. In the second embodiment of the present invention as shown in FIG. 5, the channel (31) is a hole that is situated on the axis of the handle and parallel to the axis of the cavity and this type is provided to a ratchet wrench that has a small size.

Although the invention has been explained in relation to its preferred embodiment, it is to be understood that many other possible modifications and variations can be made without departing from the spirit and scope of the invention as hereinafter claimed.

1. A ratchet wrench comprising:
a handle with an enlarged head formed on one end of the handle and a neck integrally formed between the handle and the enlarged head, a cavity defined in and extending through the enlarged head, the cavity having an axis perpendicularly corresponding to that of the handle, a ratchet set pivotally received in the cavity and having multiple rotors rotatably abutting an inner periphery of the cavity, an actuated stub centrally extending from the ratchet set for driving a workpiece, a channel defined in the neck, thereby a thickness between the channel and the cavity is equal to the thickness between the inner periphery of the cavity and an outer periphery of the enlarged head to promote the effect of heat treatment in the inner periphery of the cavity.

2. The ratchet wrench as claimed in claim 1, wherein the channel is arc and has a curvature corresponding to that of the cavity.

3. The ratchet wrench as claimed in claim 1, wherein the channel is a hole that is situated on the axis of the handle and parallel to the axis of the cavity.
